(19) United States
(12) Patent Application Publication
(10) Pub. No.: US 2022/0007756 A1
(43) Pub. Date: Jan. 13, 2022

(54) Protective Mask and Manufacturing Method Thereof

(71) Applicant: Vivian CHAN, Arcadia, CA (US)

(72) Inventor: Vivian CHAN, Arcadia, CA (US)

(21) Appl. No.: 16/925,637

(22) Filed: Jul. 10, 2020

(51) Int. Cl. A41D 13/11

(52) U.S. Cl. CPC A41D 13/1107; A41D 13/1161

(57) ABSTRACT

A protective mask includes a cover body configured for fittingly covering the user's face and a wearing device configured wearing the cover body on the user's face, so as to allow the air to enter only through the protective mask as much as possible, which minimizes the change for air to enter through the gap between the mask and the face, so as to ensure the protection.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to the field of mask, and more particularly to a protective mask and manufacturing method thereof.

### Description of Related Arts

A mask is utilized for covering the user's face, so as to shield at least part of the face, such as mouth or nose. A mask can also filter so as for preventing harmful materials, such as dust, bacteria, viruses, and etc., in the air from attaching on the face or entering the mouth or nose of the user. Accordingly, the quality for a mask on fittingly wearing on the user's face is relatively high. A breathing mask is a common mask, utilized in covering the user's mouth and nose for filtering harmful particles of the environment.

Conventional mask is usually made by heat sealing laminated multi-layer materials. A finished mask is flat and plane with a shapeable strip on the upper portion thereof. When this type of mask is worn on the user's face for utilization, the mask made of soft material can transform in order to fit the facial outline of the user. Although the shapeable strip on the mask is able to be pressed to transform and fit the curved surface shape of the nose, the transformed flat and plane mask is in fact hard to completely match and fit the three-dimensional facial outline of the user in the actual utilization scenario. This allows air of the outside environment directly be breathed and entering the user's nose through the gap and opening formed between the mask and the user's face, which renders protection failure of the mask.

In order to address the above issues and to allow the mask to be fittingly worn on the user's face as possible, mask producers, as 3M, currently apply a solution that utilizes elastic ear loops and hanging brackets to exert pulling force and stress on the user's face and ears, so as to tightly and fittingly mounted the cover of the mask on the user's face. This renders a problem of increasing pulling force to the user's ears and stress to the user's face, which causes the users difficult to wear the mask for long. Otherwisecreases may result on the user's face and ears.

In addition, when a flat and plane mask is covered on the user's face, the cover of the mask made of soft material will naturally lean on the user's skin and be shaped according to the user's facial contours. The air exhaled by the user and, for example, moisture in the air can also easily be attached on the inner wall of the cover of the mask, rendering failure of the protection of the mask. It is worth mentioning that the failure of the mask under this circumstance is not caused by the expiration of the filtering layer. Rather, it is due to the pollution on the filtering layer. Namely, the service life span of the mask has been reduced.

Further, when the user exhales and inhales, the soft cover of the mask can move along with the air flow or even lean on the surface of the user's nasal cavity opening, which not only discomforts the user, but also stimulates the user to constantly adjust the mask and pull out the mask to avoid the inner wall of the mask from contact his/her nasal cavity opening. When the user's hands touch the outside of the mask, it renders the pollutants attached on the outer wall of the mask contaminate the user's hands, which leads a secondary contamination.

### SUMMARY OF THE PRESENT INVENTION

An object of the present invention is to provide a protective mask and manufacturing method thereof, wherein the protective mask is capable of fitting the user's face better, which facilitates close and fitting attachment between the protective mask and the user's face, such that the air inhaled by the user must pass through the protective mask before entering the mouth and nasal cavity of the user and being inhaled.

Another object of the present invention is to provide a protective mask and manufacturing method thereof, wherein the protective mask is capable of being shaped according to the shapes of the nose, face, and chin of the user, so as to better fit the facial contours of the user.

Another object of the present invention is to provide a protective mask and manufacturing method thereof, wherein the protective mask ensures the fitting attachment on the user's face, and is suitable for being worn for a long time.

Another object of the present invention is to provide a protective mask and manufacturing method thereof, wherein the protective mask is capable of being fitted and closely worn on the user's face, while the corresponding pressure can be released to the user's ears.

Another object of the present invention is to provide a protective mask and manufacturing method thereof, wherein the protective mask is capable of being fitted and closely attached on the user's face, while the corresponding pressure can be released to an ear set of the protective mask and be released through the user's ears, so as to reduce the stress to the user's ears.

Another object of the present invention is to provide a protective mask and manufacturing method thereof, wherein the protective mask provides a respiratory cavity which not only allows the nasal cavity opening of the user to keep a distance from the protective mask, but also allows the user to feel more comfortable when wearing the protective mask.

Another object of the present invention is to provide a protective mask and manufacturing method thereof, wherein the protective mask provides a mounting pocket, wherein a cover of the protective mask allows a functional insert member to be mounted therein and the functional insert member is adapted for being dismantably mounted through the mounting pocket.

Another object of the present invention is to provide a protective mask and manufacturing method thereof, wherein the functional insert member is mounted in the mounting pocket, wherein the mounting pocket protects the functional insert member, so as to prevent the air exhaled by the user from polluting the functional insert member, which helps to extend the service life span of the functional insert member.

Another object of the present invention is to provide a protective mask and manufacturing method thereof, wherein the protective mask is capable of relatively and comprehensively covering the user's face from the bottom of the eyes to the chin and from one side of the face to the other.

Another object of the present invention is to provide a protective mask and manufacturing method thereof, wherein the cover of the protective mask is designed to be reusable, wherein the cover may be made of washable material with features of breathable and comfortable after a predetermined number times of use.

Another object of the present invention is to provide a protective mask and manufacturing method thereof, wherein the protective mask is capable of being mounted on the goggles worn by the user, so as to allow the protective mask and the goggles to jointly protect the user's face.

Another object of the present invention is to provide a protective mask and manufacturing method thereof, wherein the protective mask can be hung on the user when not in use, such that when the user needs to use the protective mask, s/he can wear it again easily.

According to an aspect of the present invention, the present invention provides a protective mask, adapted for covering a face of a user, wherein the protective mask includes:

an upper forming member; and

a cover body, adapted for covering the face of the user, having an upper edge adapted for being extended to an above portion of a nasal cavity opening (nostril) of the user, and a lower edge adapted for being extended to a chin of the user, wherein the upper forming member is long and thin and arranged along the upper edge, wherein when the upper forming member is supported on the nose bridge, the upper forming member is allowed to be formed and shaped according to the outline of the nose bridge, so as to allow the upper edge of the cover body to be fittingly in contact with the face, wherein the cover body is configured to form a respiratory cavity after the protective mask is worn on the face of the user, so as to allow a part of the cover body in front of the nasal cavity opening to keep a distance from the nasal cavity opening when the protective mask covers the face, wherein the cover body comprises an outer layer and an inner layer and has a mounting pocket formed between the outer layer and the inner layer for receiving a functional insert member therein, wherein the inner layer provides at least a receiving opening to allow the mounting pocket to communicate with the outside of the cover body, wherein inner layer comprises a first inner layer and a second inner layer, adapted for overlapping with each other to close the receiving opening therebetween.

According to one embodiment of the present invention, the protective mask further includes a lower forming member, arranged along the lower edge, so as to allow the lower forming member to be formed and shaped along the outline of the chin when the lower forming member is supported by the chin, such that the lower edge of the cover body is fittingly in contact with the chin.

According to an embodiment of the present invention, the cover body has at least a ridge protruded thereon along the upper side of the chin and the downward extension from the nose bridge, so as to form the respiratory cavity.

According to one embodiment of the present invention, the protective mask further includes a wearing device, which comprises two ear wearing members, respectively arranged on two sides of the cover body, wherein the ear wearing members are adapted for wearing the cover body on the user's ears.

According to one embodiment of the present invention, the protective mask further includes at least a goggles mounting member, arranged on a periphery of the cover body and adapted for being connected with goggles that the user wears, so as to connect the cover body and the goggles.

According to one embodiment of the present invention, the protective mask further includes a pair of nose pad mounting members and a pair of temples mounting members, respectively arranged on a periphery of the cover body and adapted for being connected with a pair of nose pads and a pair temples of the goggles that the user wears, wherein the nose pad mounting members are adapted for being extended from the periphery of the cover body for being connected with the nose pads, wherein the temples mounting members are adapted for being extended from the periphery of the cover body to the temples of the goggles at the positions close to the user's temples.

According to another aspect of the present invention, the present invention provides a protective mask, adapted for covering a face of a user, wherein the protective mask includes:

an elastic element;

an upper forming member; and

a cover body, adapted for covering the face of the user, wherein the cover body has an upper edge adapted for being extended to an above porton of a nasal cavity opening of the user, and a lower edge adapted for being extended to a chin of the user, wherein the upper forming member is long and thin and arranged along the upper edge, wherein when the upper forming member is supported on the nose bridge, the upper forming member is allowed to be formed and shaped according to the outline of the nose bridge, so as to allow the upper edge of the cover body to be fittingly in contact with the face, wherein an end of the elastic element is extended from the upper edge to the lower edge of the same side in order to form an ear wearing member and extended to the other side along the lower edge to form another ear wearing member, wherein the lower edge is arranged along the elastic element and is movable along the elastic element, such that the protective mask is allow to fit a size of the chin through adjusting a position of the lower edge when the lower edge is fittingly attached along the chin of the user.

According to another aspect of the present invention, the present invention provides a manufacturing method of protective mask, which includes the following step:

providing a cover body of a protective mask having a respiratory cavity, wherein the cover body is adapted for covering the user's face, wherein the respiratory cavity allows a nasal cavity opening of the user to keep a distance from a part of the cover body in front of the nasal cavity opening;

providing a long and thin upper forming member on an upper edge of the cover body, wherein the upper edge of the cover body is adapted for being extended to an above portoin of the nasal cavity opening, wherein a lower edge of the cover body is adapted for being extended to a chin of the user, such that when the cover body covers the face of the user, the upper forming member is supported by the nose bridge and the long and thin upper forming member is shaped along the nose bridge, so as to allow the upper edge of the cover body to be fittingly attached along an outline of the face of the user; and

providing a mounting pocket between an outer layer and an inner layer of the cover body for receiving a functional insert member therein, wherein the mounting pocket is adapted for being connected and communicated with a receiving opening, wherein the receiving opening is formed and provided between a first inner layer and a second inner layer of the inner layer, wherein part of the first inner layer is adapted for being overlapped on the second inner layer in order to close the receiving opening.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1A is a front perspective view of a protective mask according to a preferred embodiment of the present invention.

FIG. 1B is a rear perspective view of the protective mask according to the above preferred embodiment of the present invention.

FIG. 2A is a front view of the protective mask according to the above preferred embodiment of the present invention.

FIG. 2B is a rear view of the protective mask according to the above preferred embodiment of the present invention.

FIGS. 3A-3D are schematic views illustrating the installation of a functional insert member of the protective mask according to the above preferred embodiment of the present invention.

FIGS. 3E and 3F are schematic views illustrating the wearing of the protective mask on a user's face according to the above preferred embodiment of the present invention.

FIG. 4 is a side view of the protective mask worn on the user's face according to the above preferred embodiment of the present invention.

FIG. 5A is a front view of a protective mask according to a first alternative mode of the above preferred embodiment of the present invention.

FIG. 5B is a rear view of the protective mask according to the first alternative mode of the above preferred embodiment of the present invention.

FIGS. 6A-6B are schematic view illustrating the wearing of the protective mask on a user's face according to the first alternative mode of the above preferred embodiment of the present invention.

FIG. 7 is a side view illustrating the wearing of the protective mask according to the first alternative mode of the above preferred embodiment of the present invention.

FIG. 8 is a rear perspective view of a protective mask according to a second alternative mode of the above preferred embodiment of the present invention.

FIG. 9 is a rear perspective view of a protective mask according to a third alternative mode of the above preferred embodiment of the present invention.

FIG. 10 is a perspective view of a protective mask according to a fourth alternative mode of the above preferred embodiment of the present invention.

FIG. 11 is a perspective view of a protective mask according to a fifth alternative mode of the above preferred embodiment of the present invention.

FIG. 12 is a perspective view of a protective mask according to a sixth alternative mode of the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. just indicate relations of direction or position are based on the relations of direction or position shown in the appended drawings, which is only to facilitate descriptions of the present invention and to simplify the descriptions, rather than to indicate or imply that the referred device or element must apply specific direction or to be operated or configured in specific direction. Therefore, the above-mentioned terminologies shall not be interpreted as confine to the present invention.

It is understandable that the term “a” should be understood as “at least one” or “one or more”. In other words, in one embodiment, the number of an element can be one and in other embodiment the number of the element can be greater than one. The term “a” is not construed as a limitation of quantity.

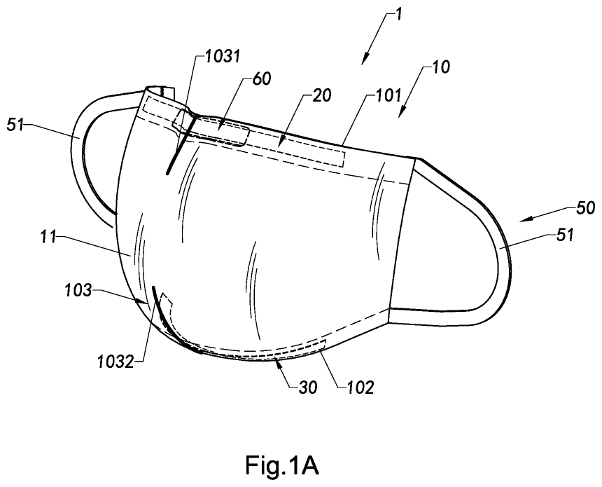

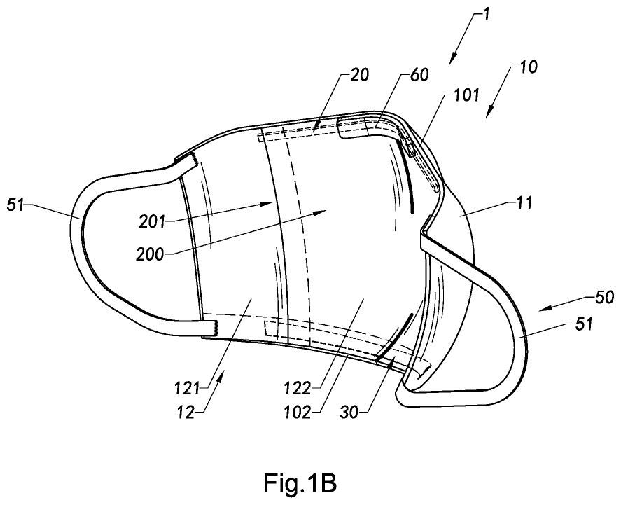

Referring to FIGS. 1A-4, a protective mask 1 according to a preferred embodiment of the present invention is illustrated. The protective mask 1 is configured to cover body at least part of a face of a user, so as to provide desired protection. Based on types of the protective mask 1, the protective mask 1 is capable of providing various types protection, such as respiratory mask, medical mask, decorative mask, and etc. For instance, it includes, but not limited to, blocking the dusts, viruses, bacteria, splash liquid, and etc. in the air, but also serve to block UV, and etc.

One of the reasons that the protective mask 1 is able to provide protection is that the external air has to pass through the protective mask 1 before entering the user's mouth or nasal cavity and being inhaled. The protective mask 1 blocks at least part of the pollutants or harmful materials in the air and only allows the air filtered by the protective mask 1 to be inhaled by the user.

It demands higher on the tightness between the protective mask 1 and the user's face, so as to avoid air from directly passing through any gap formed between the protective mask 1 and the user's face and entering the user's nasal cavity or mouth. The protective mask 1 provided by the present embodiment can be adapted for better fitting and matching the user's face contours, so as to reduce the formation of gap between the protective mask and the user's face.

In particular, the protective mask 1 includes a cover body 10, adapted for covering on at least part of the user's face. It is understandable that the protective mask 1 may not only be suitable for human, but also be designed to be suitable for animals, such as cats, dogs, and etc. Although the present invention is illustrated based on this user group as an example, nevertheless, it doesn't indicate any application or other limitation to the scope of the protective mask 1.

The cover body 10 can be extended from a bottom of the eyes to cover the user's chin as well as be extended from a side of the cheeks to cover the other side of the cheeks. The cover body 10 mainly covers the user's nasal cavity opening (nostrils), so as to prevent air from being inhaled directly into the nasal cavity of the user.

The cover body 10 has an upper edge 101 and a lower edge 102. When the cover body 10 is worn on the user's face, the upper edge 101 is preferred to be positioned below the eyes of the user and cover the face from a side of the cheeks cross the nose bridge to the other side of the cheeks. The lower edge 102 is preferred to be extended and in contact with the chin of the user. Most parts of the user, including at least the nose, cheek, and lower jaw, can be covered by the cover body 10. It is understood that pollutants in the air are blocked by the cover body 10 for the parts of the face covered by the cover body 10, so that the pollutants can be prevented from being attached on the face, which significantly ensures the cleanness of the face.

The protective mask 1 further includes an upper forming member 20, which is arranged along the upper edge 101. When the protective mask 1 is worn on the user's face, the upper forming member 20 is supported by a nose bridge of the user. The upper forming member 20 is configured to be adapted to a shape of the nose bridge and to be shaped and transformed accordingly so as to facilitate a fitting and close attachment between the upper portion of the protective mask 1 and the face of the user. For example, the part of the cover body 10 around the upper forming member 20 is capable of being shaped by the upper forming member 20 so as for fitting the user's face contours, especially the shape of the user's nose, such that the upper portion of the protective mask 1 can be attached on the user's face, that is closely and fittingly in contact with the user's face.

The upper forming member 20 can be, but not limited to, a transformable strip, a transformable belt, and etc. The shapeable member can be made of metallic material or flexible and/or deformable soft material, such as plastic wire, rubber strip and etc.

The upper forming member 20 is preferred to be extended along with the upper edge 101, so as to adaptively match the upper portion of the protective mask 1 and the face as much as possible.

The protective mask 1 further includes a lower forming member 30, which is arranged along the lower edge 102 of the cover body 10 and formed and shaped along the outline of the chin of the user so that the lower forming member is able to be supported by the chin. When the protective mask 1 is covered on the user's face, the lower forming member 30 is configured to be supported by the chin. The lower forming member is preferred to be adapted to a shape of the chin of the user and to be shaped and transformed accordingly so as to facilitate the fitting and close attachment between the lower portion of the protective mask 1 and the face of the user.

The lower forming member 30 can be, but not limited to, a transformable strip, a transformable belt, and etc. The lower forming member 30 can be made of metallic material or flexible and/or deformable soft material, such as plastic wire, rubber strip and etc.

Further, the cover body 10 of the protective mask 1 is configured to form and provide a respiratory cavity 100 between the cover body 10 and the face of the user when the protective mask 1 is worn on the user's face. Specifically, the respiratory cavity 100 is defined between the inner wall of the cover body 10 and the face of the user. The existence of the respiratory cavity 100 not only provides a buffer space for the air, but also keeps a distance from the cover body 10 and the user's nasal cavity opening as mush as possible, so as to prevent direct contact between the inner wall of the cover body 10 and the nasal cavity opening for the user during breathing and discomfort rendered by such contact.

The cover body 10 forms at least one ridge 103 in order to provide a spatial structure, ensuring the respiratory cavity 100 is formed between the cover body 10 and the user's face after the protective mask is worn on the user's face. The quantity of the ridge 103 can be one or more. In the present embodiment, the ridge 103 includes a first ridge 1031 and a second ridge 1032. The first ridge 1031 and the second ridge 1032 can be arranged along an above-below direction, a left-right direction or other direction with respect to the face's contours. In the present embodiment, it is illustrated with the example that the first ridge 1031 and the second ridge 1032 are respectively arranged along the above-below direction.

At least part of the cover body 10 protrudes frontwards to respectively form the first ridge 1031 and the second ridge 1032. The first ridge 1031 is arranged along the nose bridge. The second ridge 1032 is formed through being arranged upwardly along the chin. The respiratory cavity 100 is preferred to be formed and located in front of the nasal cavity opening and the mouth opening, so as to keep the nasal cavity opening and the mouth opening from contacting the inner wall of the cover body 10, which helps to maintain the cleanliness of the inner wall of the cover body 10 as well as the hygiene of the nasal cavity opening and the mouth opening.

Further, the protective mask 1 has at least a mounting pocket 200 formed therein and includes at least a functional insert member 40. The functional insert member 40 is configured to be received and mounted in the mounting pocket 200 for desired purposes. For example, the functional insert member 40 can be a filter element, so as for filtering, such as PM2.5 particles, germs, bacteria, virus, micro organism, and etc., depending on the material used. The functional insert member 40 received and mounted in the mounting pocket 200 is replaceable. The user may not only select and mount the functional insert member 40 that meets his/her needs, but also replace the functional insert member 40 when the service life span of the functional insert member 40 is about to end. The mounting pocket 200 not only provides a receiving cavity and mounting position for the functional insert member 40, but also provides protection for the functional insert member 40 to a certain extent.

In particular, the cover body 10 includes an outer layer 11 and an inner layer 12 connected edge to edge together so as to form and define the mounting pocket 200 between the outer layer 11 and the inner layer 12. The mounting pocket 200 is made to have at least one receiving opening 201 of the cover body 10 for being communicated with outside for the user to insert the functional insert member therethrough. The receiving opening 201 is configured to be adapted for receiving the functional insert member 40. The functional insert member 40 may also be taken out for replace through the receiving opening 201.

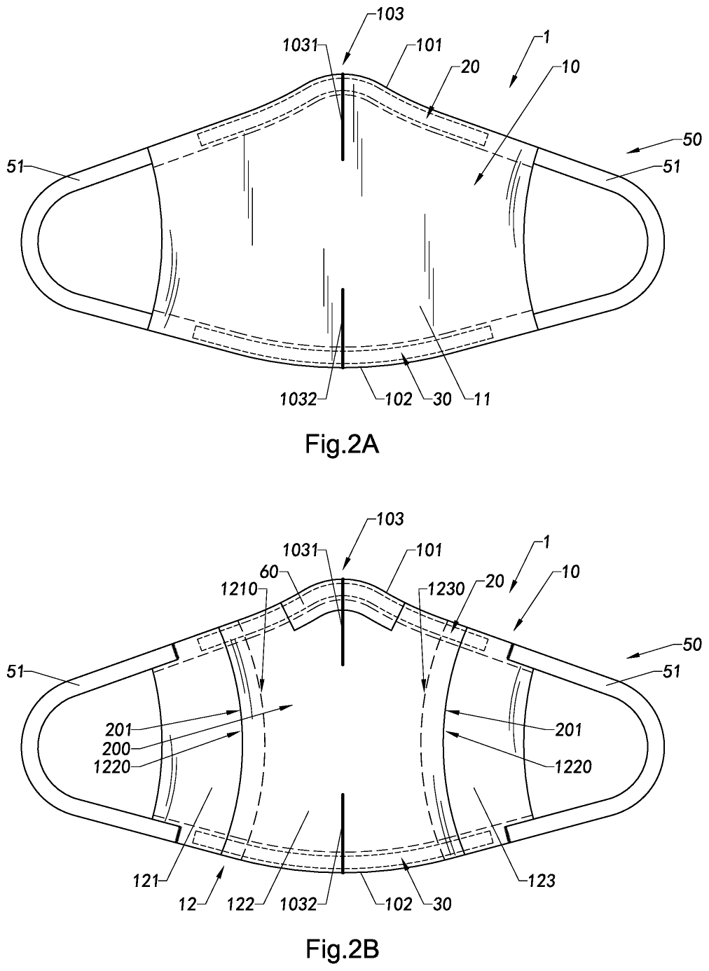

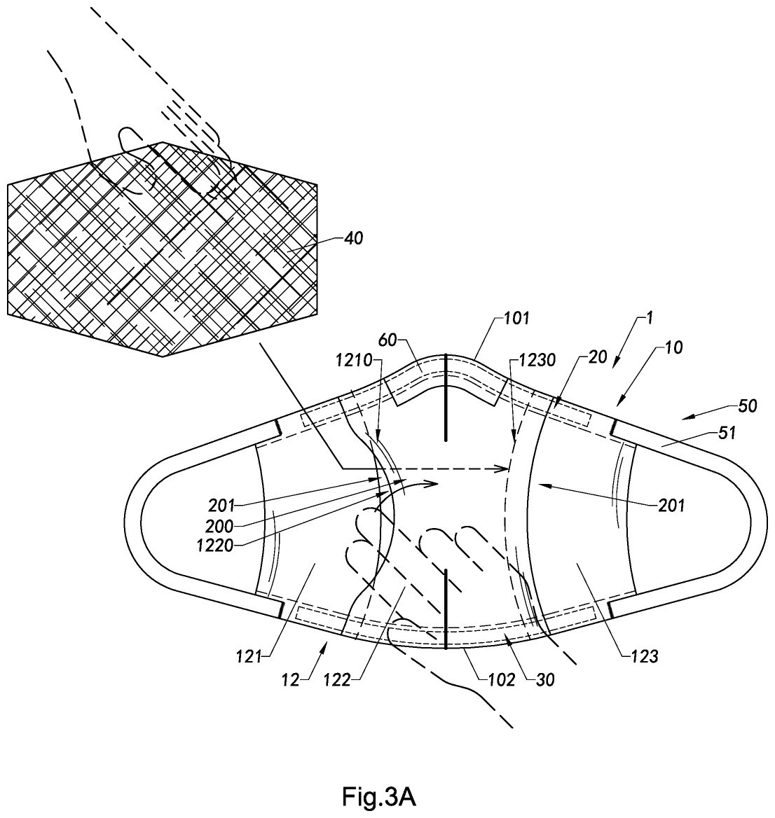

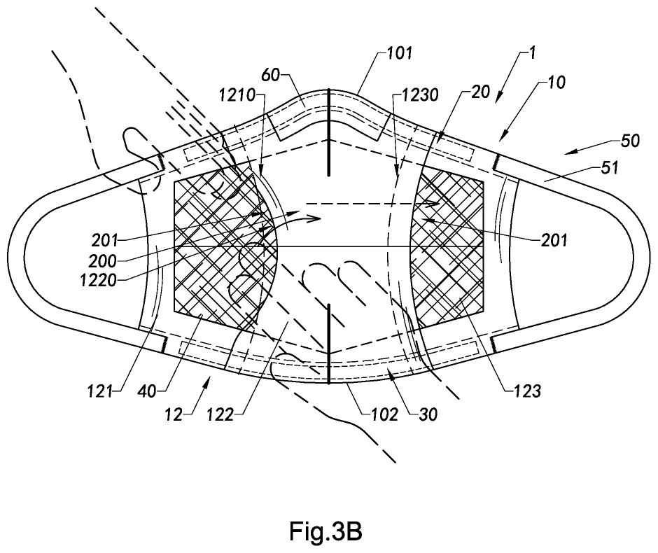

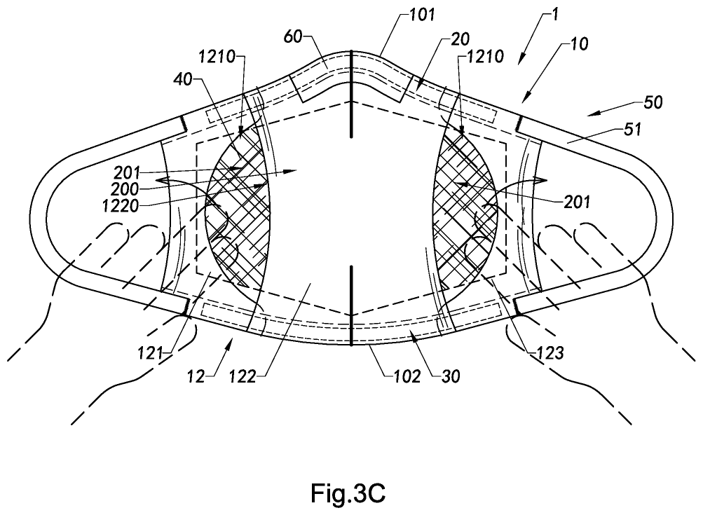

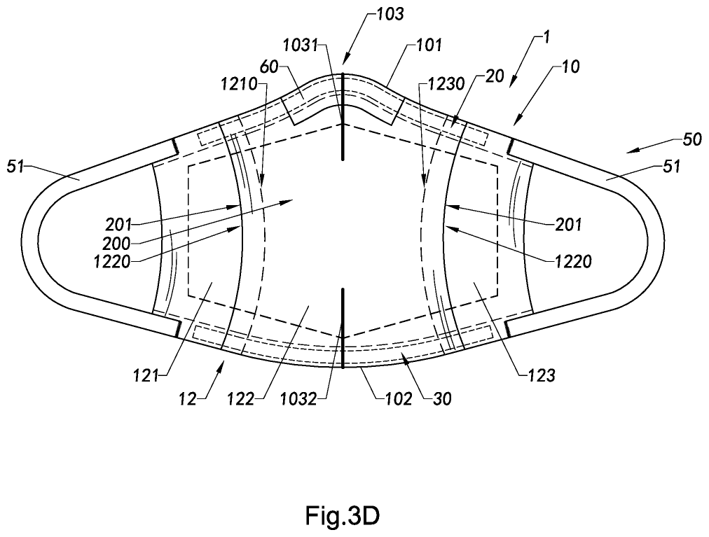

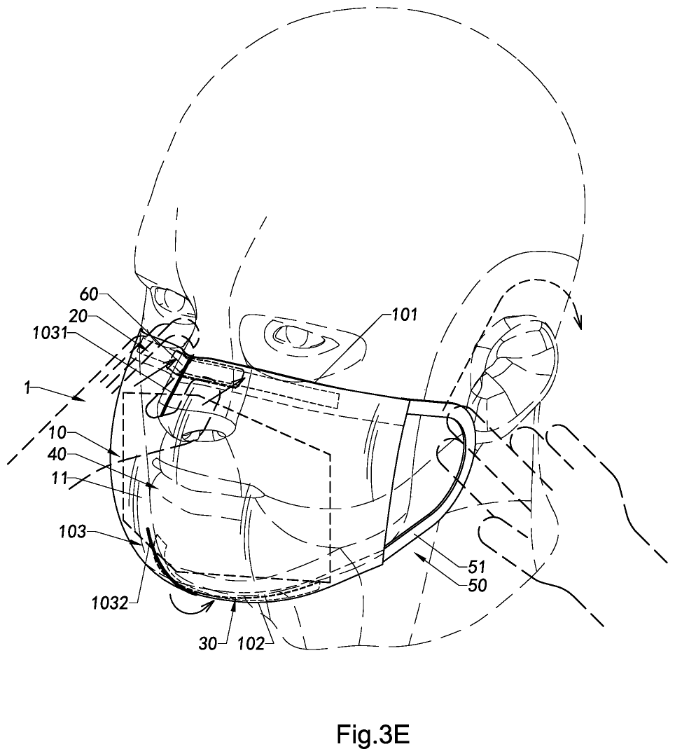

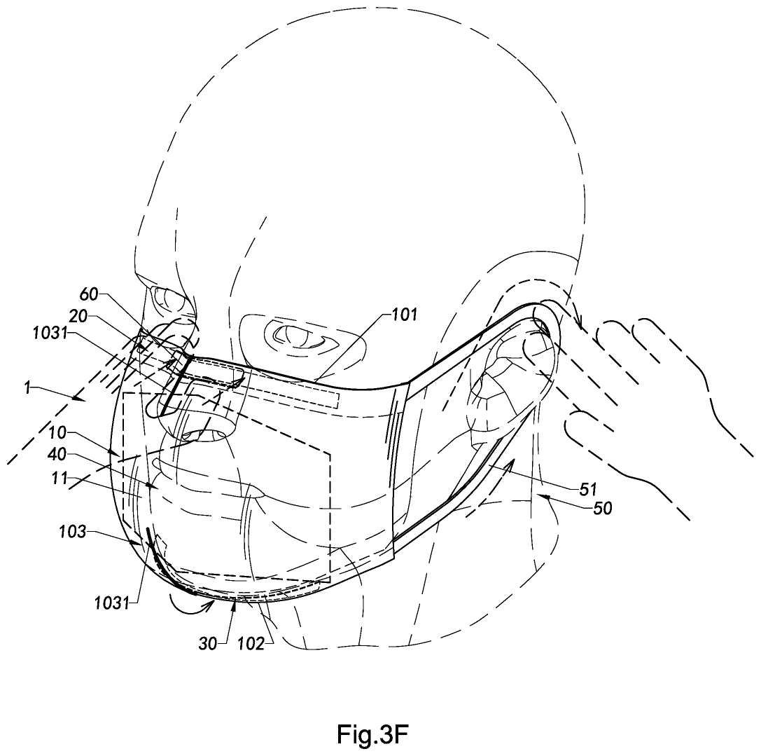

More specifically, the receiving opening 201 of the mounting pocket 200 is formed in the inner layer 12, wherein at least a part of the inner layer 12 has two construction layers, which overlap with each other to form the receiving opening 201. In the present embodiment, it is preferred to have a pair of receiving openings 201 formed at two sides of the inner layer 12 respectively, as shown in FIGS. 2B-3D.

According to the preferred embodiment of the present invention, as shown in FIG. 2, the inner layer 12 includes a first inner layer element 121, a second inner layer element 122, and a third inner layer element 123. An outer edge, an upper edge and a lower edge of the first inner layer element 121 are connected with the outer layer 11, that allows a first opening 1210 to be formed and provided between an inner edge of the first inner layer element 121 and the outer layer 11. An outer edge, an upper edge and a lower edge of the third inner layer element 123 are connected with the outer layer 11, that allows a third opening 1230 to be formed and provided between an inner edge of the third inner layer element 123 and the outer layer 11. An upper edge and a lower edge of the second inner layer element 122 are connected with the outer layer 11 while two side edges of the second inner layer element 122 sidewardly extended to cover the inner side edges of the first and third inner layer elements 121, 123 respectively, and thus covering the first and second openings 1210 and 1230 too. Accordingly, the two side edges of the second inner layer elements 122 remained opened to form a pair of second openings 1220 between the second inner layer elements 122 and the outer layer 11. Accordingly, the pair of second openings 1220 and the first and second openings 1210 and 1230 substantially form the pair of receiving openings 210 of the mounting pocket 200 respectively. Correspondingly, the first, second and third inner layer elements 121, 122, 123 of the inner layer 12 and the outer layer 11 form the mounting pocket 200 therebetween while the receiving openings 201 communicating the mounting pocket 200 with outside.

A first folded portion is formed where the one side edge portion of the second inner layer element 122 and the inner side edge portion of the first inner layer element 121 are overlapped and form one of the receiving openings 201. A second folded portion is formed where another side edge portion of the second inner layer element 122 and the the inner side edge portion of the third inner layer element 123 are overlapped and form the other receiving openings 201. In other words, the two side edge portions of the second inner layer element 122 overlapping the inner edge portions of the first and third inner layer elements 121 and 123 substantially close the two receiving openings 201 respectively.

The shape of the functional insert member 40 is arranged to match with the shape of the mounting pocket 200, preferrably having a size slightly smaller than a size of the mounting pocket 200, so as to provide maximum protection. An upper edge and a lower edge of the functional insert member 40, for example made of sheet like filter material, are shaped according to the shapes of the upper edge 101 and lower edge 102 of the cover body 10 while a length of the functional insert member 40 is longer than that second inner layer element 122 but shorter than that of the cover body 10, such that two side edges of the functional insert member 40 are extended to be below the first and third inner layer elements 121 and 123 through the first and second openings 1210 and 1230 respectively. Since the two receiving openings 201 are respectively at the two side portion of the inner layer 12, the user may insert or take out the functional member 40 through one of the receiving openings 201. After the functional insert member 40 is inserted into the mounting pocket 200, the user may also utilize the two receiving openings 201 to reach and contact the two side edges of the functional insert member 40 to adjust the position of the functional insert member 40 to align with the mounting pocket 200 properly and easily by simply pulling left and right. Finally, the user can put the two side edges of the functional insert member 40 to position under the the first inner layer element 121 and the second inner layer element 122 through the first and scond opening 1210, 1230 respectively, so as to enclose the functional insert member 40 properly positioned inside the mounting pocket 200 while the first and second inner layer elements 121, 122 being substantially utilized for press fitting the functional insert member 40 in position to avoid any lateral movement while the protective mask 1 with the functional insert member 40 are worn on the user's face.

In particular, the two side edges of the second inner layer element 122 is arranged to cover the outer side edges of the third inner layer element 123 and the first inner layer element 121. When the functional insert member 40 has to be mounted, at least one of the two side edges of the second inner layer element 122 can be lifted up to open the corresponding second opening 1220, as shown in FIG. 3A, so that the functional insert member 40 is able to be inserted through the corresponding second opening 1220, as shown in FIG. 3B, to extend under the second inner layer element 122. In this process, the two side edges of the functional insert member 40 can be remained overlapping on the first inner layer element 121 and the third inner layer element 123.

After the functional insert member 40 is mounted between the second inner layer element 122 and the outer layer 11 as illustrated in FIG. 3B, the first inner layer element 121 and the third inner layer element 123 can be respectively pulled out to respectively reveal the first opening 1210 and the third opening 1230, as shown in FIG. 3C, so as to open the two receiving openings 201 and allow the two side edges of the functional insert member 40 to be inserted through the first and third openings 1210, 1230 respectively and positioned under the first inner layer element 121 and the third inner layer element 123 respectively, and then the pair of receiving openings 201 are closed by ensuring the two side edges of the second inner layer element 122 to cover and overlap again on the two outer side edges of the first and second inner layer elements 121, 123, as shown in FIG. 3D. Accordingly, the functional insert member 40 is completely placed inside mounting pocket 200 while the user may still try to adjust a preferred position of the functional insert member 40 through the two receiving openings 201 by pulling left or right of the functional insert member 40.

It is worth mentioning that since the first inner layer element 121 and the third inner layer element 123 are configured to overlap with two side portions of the functional insert member 40 inserted in the mounting pocket 200, the functional insert member 40 can be restricted in position by the first and third inner layer elements 121, 123, especially when the protective mask 1 is worn on the user's face, such that the functional insert member 40 can be stably retained in the mounting pocket 200 to ensure the best filtration and/or other protection purposes. At the same time, the two side edges of the second inner layer element 122 are configured to overlap on the outer side edges of the first and third inner layer elements 121, 122 that substantially closes the receiving openings 201 too. When the protective mask 1 is in use, the inner layer 12 will be worn closely to and completely cover the user's nose and mouth. Here, the closed receiving openings 201 configuration can protect the functional insert member 40 through preventing the filtered air exhaled from the nasal cavity or mouth from affecting the functions of the functional insert member 40.

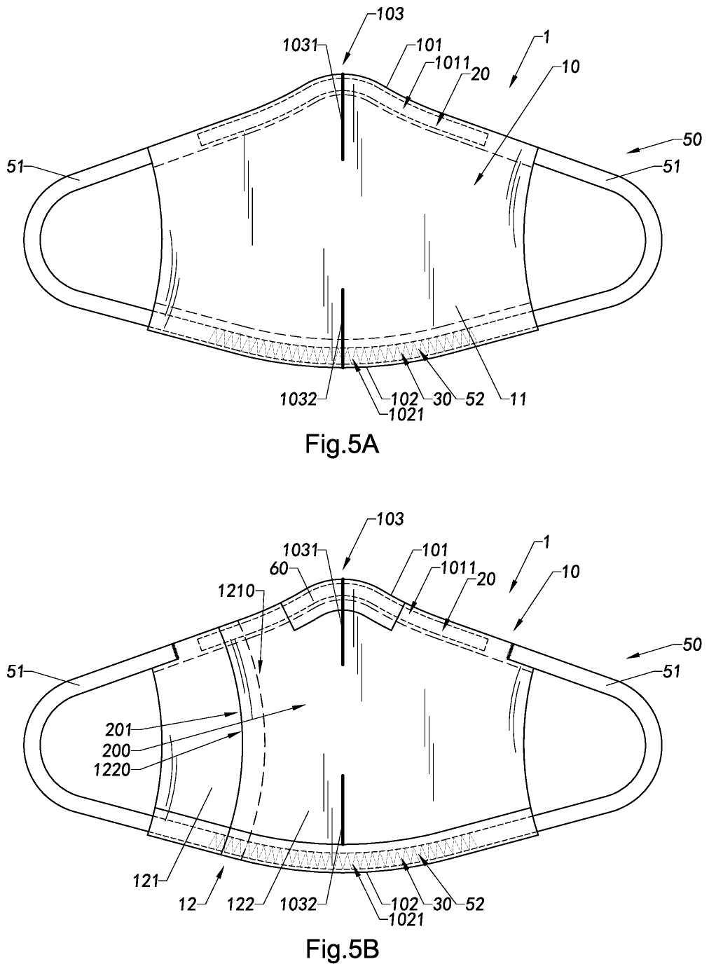

It is understandable that, according to the present embodiment, although the protective mask 1 is preferred to be embodied to have two the receiving openings 201 at two sides of the inner layer 12 of the cover body 10, as shown in FIGS. 1 to 4, the protective mask 1 of the present invention may also embodied to at least provide one receiving opening 201 at one side of the inner layer 12 of the cover body 10, as shown in FIG. 5B.

It is appreciated that the at least one receiving opening 201 may also be simply on the front surface of the cover body 10, that is in the outer layer 11, due to the overlapping configuration of the second opening 1220 with the first and third openings 1210, 1230. Or, alternatively speaking, the user may wear the protective mask 1 of the present invention on both side by utilizing the outer layer 11 or the inner layer 12 as the front side, i.e. selectively facing the outer layer 11 or the inner layer 12 outside. It is also worth mentioning that the at least one receiving opening 201 may be arranged to face upward or downward, so that the functional insert member 40 can be inserted into the mounting pocket 200 from the top or bottom in an up-down manner. These are simply modifications according to the disclosure of the present invention to person skilled in the art, and thus such modifications should be considered as within the scope of the claimed invention of the present invention.

Further, at least a portion of the inner layer 12 may be made of waterproofing material or with waterproof treatment, including at least the portion of the inner layer 12 that faces the mouth opening or in front of the nasal cavity opening. According to the first preferred embodiment of the present embodiment, the second inner layer element 122 of the inner layer 12 is made of waterproofing material or with waterproof treatment, such as coated with waterproofing layer.

Further, it is worth mentioning that the functional insert member 40 does not restrict the above exemplarily mentioned filtering layers. The functional insert member 40 may include one or more layers, including such as a supporting layer for supporting the face. The functional insert member 40 can be a face reshaping layer, so as to reshape an outline of the user's face, so as to artistically improve the user's face appearance wearing the protective mask 1. The functional insert member 40 can be a filtering member jointly formed with one or more layers of laminated paper or fabric, or a whole breathing mask, such as some medical breathing mask. When some medical breathing mask is solely used, the inner layer 12 thereof may fail due to the moisture exhaled by the user. Nonetheless, if a traditional medical mask is used as the functional insert member 40 to be placed in the mounting pocket 200, its service life span can be extended because of the protection of the mounting pocket 200. The functional insert member 40 may also be embodied as an article with special scent. For example, the functional insert member 40 may carry some protective Chinese herb or refreshing volatile oil.

The inner layer 12 of the cover body 10 may also be made of breathable material or sweat absorbing material. Because the cover body 10 covers the user's face, the user may feel uncomfortable due to muggy feelings of the face, hence the use of breathable or sweat absorbing material may help the user to feel more comfortable.

The cover body 10 of the protective mask 1 is designed to adaptively match the user's face, so as to ensure the leak-proof quality and tightness between the protective mask 1 and the user's face. Further, the protective mask 1 is designed to be tight and fittingly attached on the user's face in order to reduce the likelihood of the air entering through a gap.

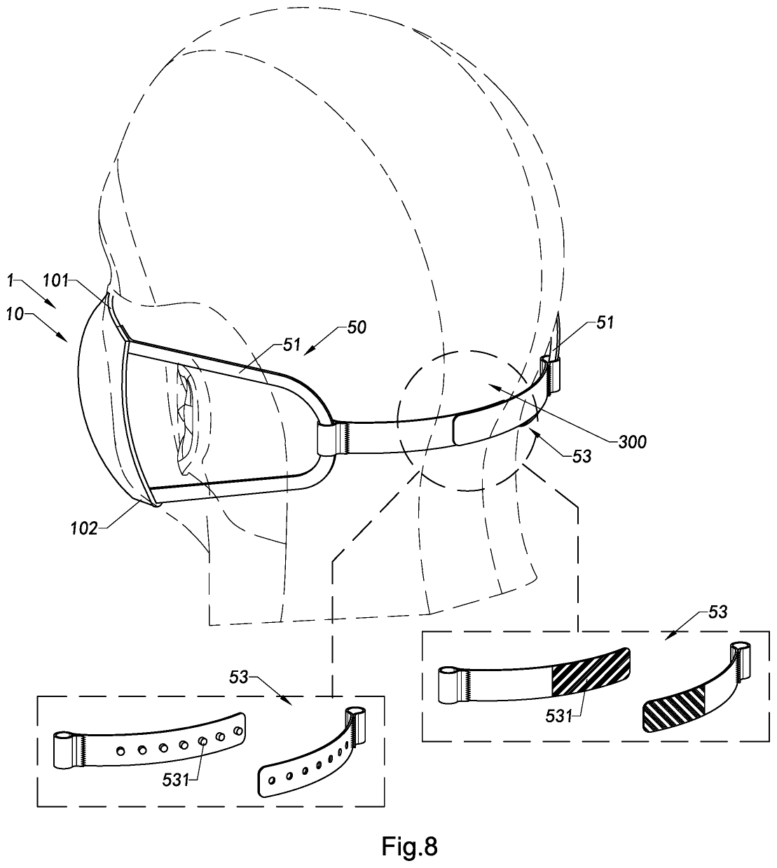

The protective mask 1 further includes a wearing device 50 coupled with the cover body 10 and configured for fittingly wearing the cover body 10 on the user's face. The wearing device 50 is adapted for being worn on the user's head directly or indirectly. For instance, it may be worn on the user's head or ears. In the first preferred embodiment, as shown in FIGS. 1A, 1B, 3E, 3F, the wearing device 50 is hanged on the user's ears so as to wear the cover body 10 of the protective mask 1 on the user's face. According to another alternative mode of the preferred embodiment of the present invention, the protective mask 1 can also be worn on the head through the wearing device 50, as shown in FIGS. 8-12.

According to the preferred embodiment of the present embodiment, the wearing device 50 includes two wearing members 51 respectively arranged on the two sides of the cover body 10. According to the preferred embodiment, the two wearing members 51 are are two loop shaped ear wearing members so as to allow the cover body 10 being positioned in front of and covering the user's face by hanging the two ear wearing members 51 on the two ears of the user respectively, as shown in FIG. 1A to FIG. 7. The ear wearing members 51 are designed to be expandable, such as made of elastic bands, in order for adaptation for various users, such that the cover body 10 can be closely and fittingly attached on the user's face through the pulling force and stress of the ear wearing members 51. The ear wearing member 51 may be a flexible gasket for the sake of the user's comfort of wearing. Alternatively, the ear wearing member 51 may be a flexible strap made of comfort fabric or simply an elastic band, having two ends connected to the top and bottom ends of the side edge of the cover body 10 respectively.

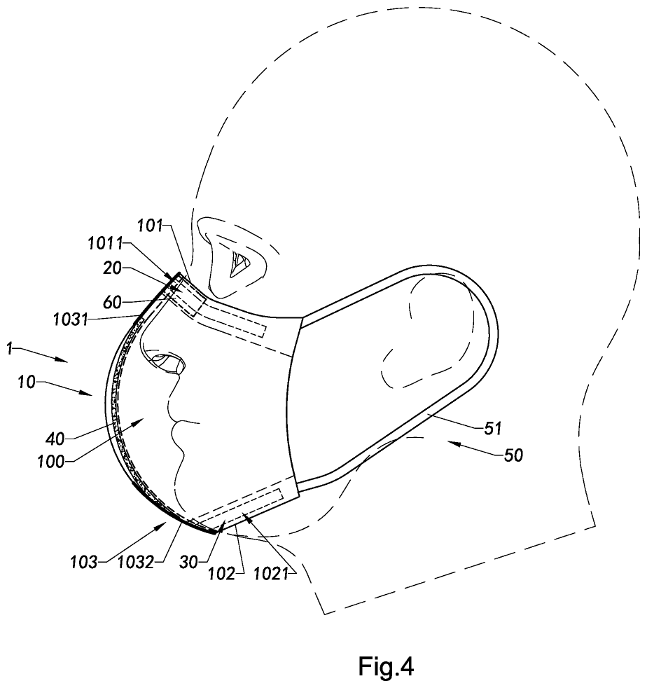

It is worth mentioning that the upper edge 101 of the cover body 10 has a generally “Λ” shape forming an upward ridge for positioning at the tip of the nose bridge of the user as high as possible while extending gradually in an inclined manner downwarly and outwardly towards the two ear wearing members 51 respectively, as shown in FIGS. 2A, 2B, 3D and 3F. Also, the lower edge 102 of the cover body 10 has a generally “ [symbol] ”shape forming a downwardly curved edge for positioning at the chin position of the user while extending gradually in an inclined manner upwardly and outwardly towards the two ear wearing members 51 respectively. In addition, as shown in FIGS. 3E, 3F and 4, the two side portion of the cover body 10 are fitted on and smoothly in contact with the two cheeks of the user's face and a central portion of the cover body 10, extending between the upper edge 101 to the lower edge 102, is curvely shaped frontwardly, while the upper edge 101 is fitted on the nose bridge of the user and the lower edge 102 is fitted on the chin of the user, such that after the protective mask 1 is worn on the user's face as shown in FIG. 4, a respiratory cavity 100 is defined and formed between the inner layer 12 and the user's face, i.e. the breathing area of the user.

In view of above, the upper edge 101 with the upper forming member 20 therein, the lower edge 102 and the two side portions of the cover body 10 equipped with the wearing device 50 are designed for a tightly fitting manner for better coverage and protection of the nose and mouth of the user when the protective mask 1 is worn on the user's face, wherein the cover body 10 significantly covers as much area as possible in front of the user's breathing area, i.e. the front portion of the nose and mouth area of the user. Correspondingly, since the cover body 10 of the protective mask 1 itself has been designed to adaptively fit the user's face, the cover body 10 does not require too much pressure for deforming the cover body 10 for ensuring the seal and tightness between the cover body 10 and the user's face. Hence, the stress to the user's face and ears can be reduced. The cover body 10 can be attached on the face fittingly through the wearing device 50 that provides a certain acting force. The user can wear the protective mask 1 for a long enough time without feeling his/her face or ears being strapped too tight.

The protective mask 1 further includes a cushion pad 60. The cushion pad 60 can be arranged on the upper edge 101 of the cover body 10, preferably attached to the upper edge of the inner layer 12 of the cover body 10, as shown in FIG. 1B, covering the upper forming member 20 at the upper edge 101, so that when the nose bridge supports with the upper edge 101 which as shaped by the upper forming member 20 according to the shape of the nose, the cushion pad 60 can provide a cushioning effect between the nose bridge and the upper forming member 20, so as to reduce the user's discomfort rendered by the deformed upper forming member 20 after a long use. The cushion pad 60 may be made with sponges or other material with certain elasticity. The cushion pad 60 can be arranged at other position, such as the positions of the ear wearing members 51, so as to ease the stress to the ears.

According to another aspect of the preferred embodiment of the present invention, a manufacturing method of protective mask 1 is provided, which includes the following steps:

(a) providing the cover body 10 shaped to be fittingly worn on a user's face while defining and forming the respiratory cavity 100 between the cover body 10 and the nose, including the nasal cavity opening, and the mouth of the user;

(b) arranging the long and thin upper forming member 20 on the upper edge 101 of the cover body 10, so as to shape the upper edge of the cover body 10 according to the shape of user's nose that ensures the user's nose bridge well supporting the cover body 10 through its upper edge 101 and upper forming member 20, wherein the upper forming member 20 shaped along the shape of the nose bridge also ensures an air-tightly and fittingly attachment of the cover body 10 on the nose bridge; and

(c) providing the mounting pocket 200 in the cover body 10, wherein the mounting pocket 200 is communicated with at least one receiving opening 201 which is preferred to be located at a side edge of the inner side for inserting at least one functional insert member 40 to be disposed inside the mounting pocket 200.

In one embodiment, in the step , the cover body 10 comprises the outer layer 11 and the inner layer 12, wherein the mounting pocket 200 is formed and provided between the outer layer 11 and the inner layer 12, wherein the receiving opening 201 is formed and provided between the first inner layer element 121 and the second inner layer element 122 and the part of the first inner layer element 121 is allow to overlap with the second inner layer 121, wherein when the first inner layer element 121 is overlapped with the second inner layer element 122, the receiving opening 201 will be closed.

According to the preferred embodiment of the present invention, as shown in FIG. 4, the respiratory cavity 100 is formed through the forming of the first ridge 1031 and the second ridge 1032, wherein the first ridge 1031 of the cover body 10 is formed through extending frontwardly and downwarldy from the upper edge 101 and the second ridgel 1032 is formed through extending frontwardly and upwardly from the lower edge 102. The first ridge 1031 is provided and formed preferably allowing it to be extended downward along the nose bridge of the user while the second ridge 1032 is formed preferably allowing it to be extended upward along the chin of the user when the protective mask 1 is worn on the user's face, as shown in FIGS. 3E, 3F, 4, 6A, 6B, and 7.

It is understandable that the cover body 10 may be made of breathable fabric material and the outer layer 11 and inner layer 12 are sewing edge to edge together to form the cover body 10. The fabric material may be selected based on the needs. In addition, the materials of the inner layer 12 and the outer layer 11 of the cover body 10 may be different. The material of the inner layer 12 has to contact with the user's skin, so it may selectively be breathable material or sweat absorbing material, such as cotton. The material of the outer layer 11 has to facing outside so it may selectively be particle filtering material or decorative material.

At least the first ridge 1031 may be formed by a protruding seam sewingly provided on the outer layer 11 or, alternatively a formation wire can be provided and extended from a middle position of the upper edge 101 downwards to form the first ridge 1031. Similarly, the second ridge 1032 may also be formed by a seam sewingly provided on the outer layer 11 too.

It is worth mentioning that the upper forming member 20 may also be embodied as a deformable elastic and elongated element disposed along the upper edge 101 of the cover body 10. For conventional face mask, a wire with a width of about 3 mm and a length around 3 inches is generally adhered to the inner layer of the mask by gluing or thermoplastic process. For ease of attachment, the wire is generally attached to about 3-5 mm below the upper edge of the mask, that may cause uncomfortable feeling to the user and fail to ensure an air-tight attachment with the nose bridge of the user. According to the preferred embodiment, along the upper edge 101 of the cover body 10, a tubular receiving channel 1011 may be formed between the outer layer 11 and the inner layer 12, having a size equal to or slightly larger than the upper forming member 20, so as to fittingly receive the upper forming member 20 along the upper edge 101 of the cover body 10 that significantly facilitates the upper forming member 20 to be deformed across the nose bridge according to the contour of the user's nose and extended sidewardly to the two cheeks of the user's face to ensure an air-tight manner fitting of the cover body 10 on the user's face. Alternatively, the upper forming member 20 according to the present invention may attached to the inner surface of the outer layer 11 along its upper edge and be concealed by the inner layer 12, so that the user may easily deform the upper edge 101 of the cover body 10 to fit the nose bridge of the user's nose while the inner layer 12 still provides a more comfortable contact with the user's skin.

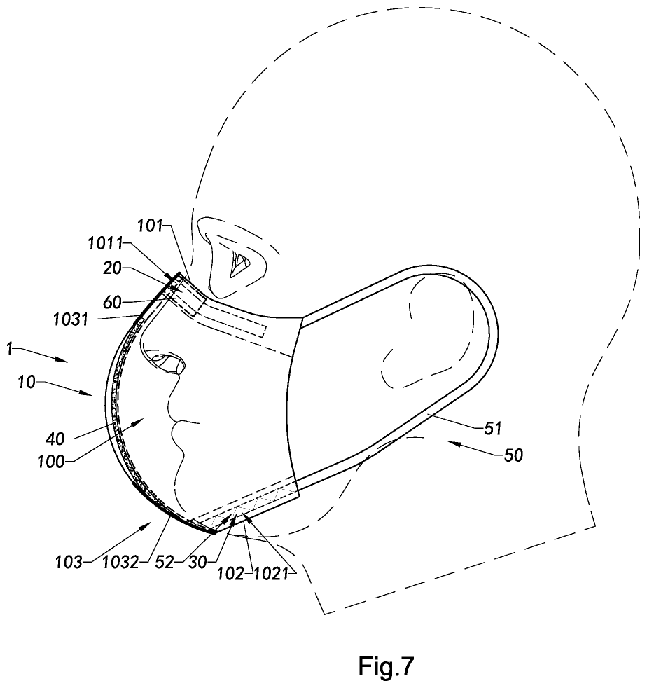

According to the preferred embodiment of the present invention, referring to FIG. 4 and FIG. 7, the lower forming member 30 is arranged on the lower edge 102 of the cover body 10, the cover body 10 is configured to have a C-shape leading front edge when viewed from a side.

In order to ensure a better support of the cover body 10 by the chin of the user, the lower forming member 30 is preferred to be arranged along the lower edge of the cover body 10 and shaped along the outline of the chin of the user, so as to allow the cover body 10 to adaptively match the user's chin. Similarly, along the lower edge 102 of the cover body 10, a tubular receiving channel 1021 may be formed between the outer layer 11 and the inner layer 12, having a size equal to or slightly larger than the lower forming member 30, so as to fittingly receive the lower forming member 30 along the lower edge 102 of the cover body 10 that significantly facilitates the lower forming member 30 to be deformed along the contour of the user's chin to ensure a better air-tight manner fitting of the cover body 10 on the user's face. Alternatively, the lower forming member 30 according to the present invention may selectively attached to the inner surface of the outer layer 11 or the inner layer 12 along its lower edge in a conceal manner, so that the user may easily deform the lower edge 102 of the cover body 10 to fit the chin of the user to better support the cover body 10 to fully cover the respiratory area of the user's face.

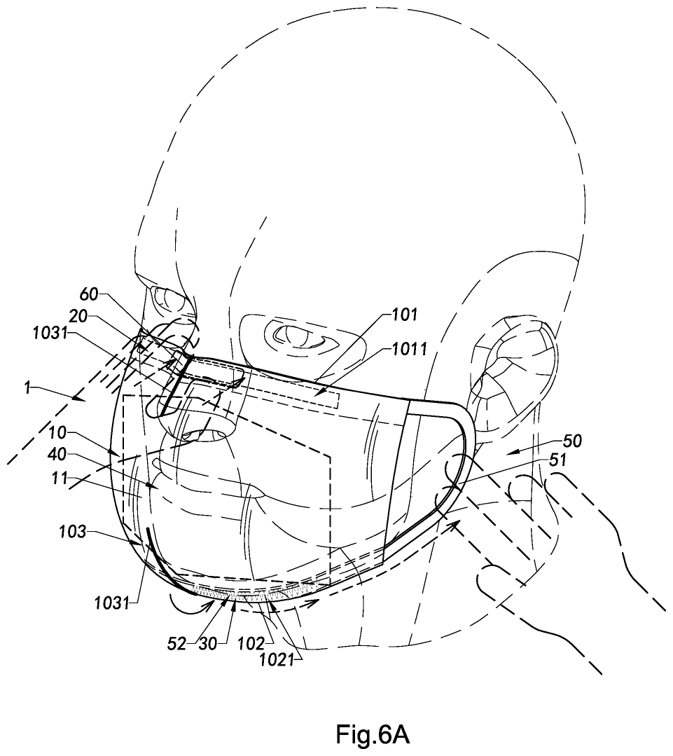

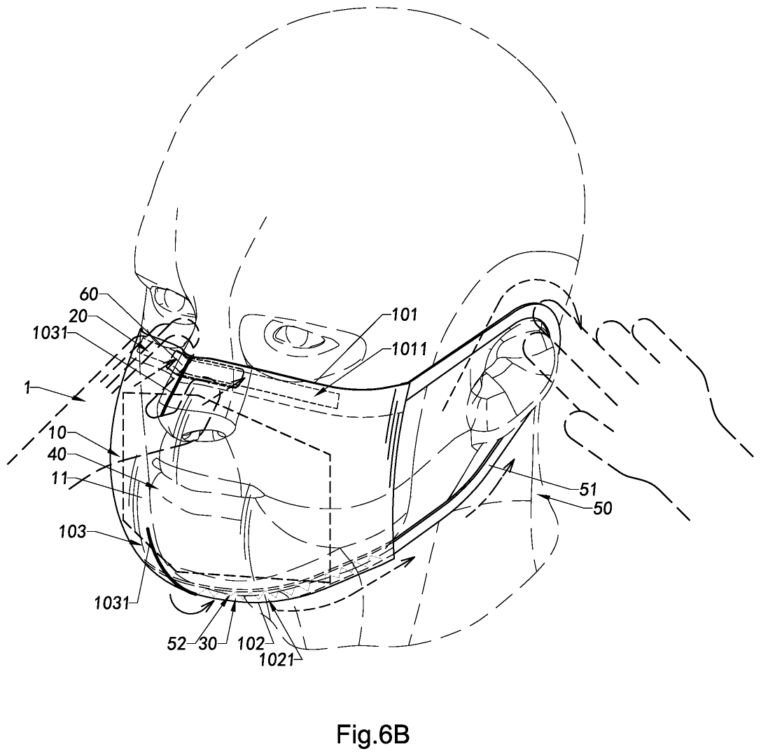

Referring to FIGS. 5A-7, a protective mask 1 according to a first alternative mode of the above preferred embodiment of the present invention is illustrated, wherein the wearing device 50 is embodied to be adjustable by an alternative mode of the low forming member 30. The wearing device 50 includes two wearing members 51 each of which is embodied as a fabric strip that can be made of the same material of the cover body 10 and has one end connected to the side portion of the upper edge 101 of the cover body 10. The low forming member 30 is embodied to comprises an adjustable element 52, made of elastic material, disposed along the lower edge 102 of the cover body 10 and the other ends of the two wearing members 51 is extended to connect with the two ends of the adjustable element 52 at the lower edge 102 of the cover body 10. According to this alternative mode, an elongated tubular receiving channel 1021 is provided at the lower edge 102 of the cover body 10 extended to the two side edges of the cover body 10, as shown in FIG. 5B, wherein the tubular receiving channel 1021 is formed by folding up the lower edge of either the outer layer 11 or the inner layer 12 of the cover body 10, or inserting and affixing a tubular member at the lower edge 102 between the outer layer 11 and the inner layer 12, wherein the tubular receiving channel 1021 has a size equal to or slightly larger than the size of the adjustable element 52, so that by pulling the two wearing member 51 away from cover body 10, as shown in FIG. 6A, the adjustable element 52 of the low forming member 30 is pulled to stretch to extend its length within the receiving channel 1021 at the lower edge 102 so that the size of each of the two wearing members 51 is enlarged for ease to extend to reach the user's ears and better fit the shape and size of the user's ears, as shown in FIG. 6B, wherein the two wearing members 51 are ear wearing members according to this first alternative mode of the preferred embodiment. In other words, the two ear wearing members 51 of the wearing device 50 of the protective mask 1 are arranged to be adjustable by means of the adjustable element 52 of the low forming member 30, so as to allow the cover body 10 to be adaptively matching with the user's face.

Preferably, the adjustable element 52, even after fully extended, is entirely concealed in the receiving channel 1021 at the lower edge 102 of the cover body 10. So that, as shown in FIGS. 6A, 6B and 7, when the two ear wearing members 51 are pulled from the cover body 10 to hang on the user's ears in order to wear the protective mask 1 on the user's face, the extended adjustable element 52 of the low forming member 30 substantially provides a restriction effect to ensure the lower edge 102 to fit along the chin of the user for fittingly and air-tightly wear the cover body 10 on the user's face.

In addition, correspondingly the lower edge 102 of the cover body 10 may be movably and expandably arranged along at least a portion of the adjustable element 52. When the distance between the ears and the nose of the user is shorter, the adjustable element 52 is less stretched to have the two ear wearing members 51 having smaller size. When the distance between the ears and the nose of the user is longer, the adjustable element 52 is stretched to much extend to have longer length to make the two ear wearing members 51 having larger size to comfortably and fittingly hang on the user's ears respectively. When the size of the chin of the user is smaller, the lower edge 102 of the cover body 10 can be pressed along the adjustable element 52 so as to fit the small chin. Meanwhile, the ear wearing members 51 at the two sides will be extended. When the size of the chin of the user is larger, the lower edge 102 of the cover body 10 can be spread along the adjustable element 52 so as to cover the big chin. Meanwhile, the ear wearing members 51 at the two sides will be reduced.

By means of the adjustable low forming member 30, the size of both the ear wearing members 51 can be adjustable according to the user's face contours. In other words, the protective mask 1 of the present invention may achieve the adaptiveness and match of the protective mask 1 for the user's chin through adjusting the relative position of the lower edge 102 and the adjustable element 52 or the ear wearing members 51.

Alternatively, the low forming member 30 may also comprises two adjustable elements 52 each having one end affixed to the lower edge 102 of the cover body 10 and another end connected to the end of the respective ear wearing member 51. In other word, each of the two adjustable elements 52 forms a part of the corresponding ear wearing member 51 while the two adjustable elements 52 that form the lower forming member 30 can adaptively match chin of various shapes.

It is understandable that the adjustable element 52 does not have to be elastic entirely. For instance, when the adjustable element 52 is a non-elastic fabric strip, it may also achieve the adaptiveness and match of the mask for different sizes of the chin through adjusting the length of the adjustable element 52 being covered by the lower edge 102. That is to say, it may stretched to expand or squeeze the lower edge 102 along the adjustable element 52 to alter the cover area of the cover body 10 for the chin or lower jaw position.

It is understandable that the lower edge 102 does not have to be movably arranged with respect to the adjustable element 52. The lower edge 102 may also be affixedly connected with the adjustable element 52, wherein this portion of the adjustable element 52 is elastic. When the adjustable element 52 is stretched, the lower edge 102 can be synchronously expanded to cover a larger chin.

Further, according to the first alternative mode of the preferred embodiment of the present embodiment, referring to FIG. 5B, the inner layer 12 is embodied to merely include the first inner layer element 121 and the second inner layer element 122, wherein there is only one receiving opening 201, formed and defined between the first inner layer element 121 and the second inner layer element 122. The corresponding side edge of the second inner layer element 122 is overlapped with the outer side edge of the first inner layer element 121, so as to allow at least the side edge of the first inner layer element 121 to be concealed so as to close up the receiving opening 201. When the mask is in use, the second inner layer element 122 and the first inner layer element 121 of the inner layer 12 can be opened to expose the receiving opening 201 to allow the functional insert member 40 to be inserted into the mounting pocket 200 formed between the first inner layer element 121 and the second inner layer element 122 through the receiving opening 201. A side portion of the functional insert member 40 can be inserted and extended to the deep side edge of the cover body 10 and the other side portion is inserted and extended under the first inner layer element 121 so as to entirely disposed the functional insert member 40 in the mounting pocket 200. In other words, the outer side edge of the first inner layer element 121 can be pulled out in order to open and expose the first opening 1210, so as to allow one side end of the functional insert member 40 to be inserted into the mounting pocket 200 through the opened receiving opening 201, and then by covering the outer side of the first inner layer element 121 with the side edge of the second inner layer element 122, the receiving opening 201 is closed up again, such that the entire functional insert member 40 can be concealed, accommodated and fully extended in all directions in the mounting pocket 200 for full protection for the cover body 10.

When the functional insert member 40 is required to be taken out for replacement of a new one, one may pull out the first inner layer element 121 to expose and open the first opening 1210, so as to allow the functional insert member 40 to be drawn out from the mounting pocket 200.

Referring to FIG. 8, a second alternative mode of the protective mask 1 according to the above preferred embodiment of the present invention is illustrated, wherein the wearing device 50 of the protective mask 1 further comprises a head wearing member 53, wherein the head wearing member 53 can be mounted on the ear wearing members 51. The cover body 10 can be worn on the head of the user through the head wearing member 53. Alternatively, the head wearing member 53 may also be mounted on the cover body 10 directly.

In particular, the head wearing member 53 comprises a male element and a female element respectively connected to the two ear wearing members 51. By detachably connecting the male and female elements of the head wearing member 53 behind of head of the user who wears the protective mask 1, the cover body 10 can be worn on the user's face and the two ear wearing members 51 can be stretched out to avoid applying stress against the ears of the user, so that the stress exerted to the user's ears by the ear wearing members 51, as in the above preferred embodiment as shown in FIGS. 1A to 8, can be transferred and released to his/her head through the head wearing member 53 that is more comfortable and rigidly mounted in position when the user have to wear the protective mask 1 for long period of time.

The protective mask 1 can be suitable for user's faces of different shapes and heads of different sizes through changing the connecting length of the head wearing member 53 between the two ear wearing members 51.

The head wearing member 53 may be made of hard material or soft material. According to the second alternative mode of the preferred embodiment, the length of the head wearing member 53 is adjustable. For instance, the head wearing member 53 may be embodied as Velcro fasteners or buckle connection as shown in FIG. 8.

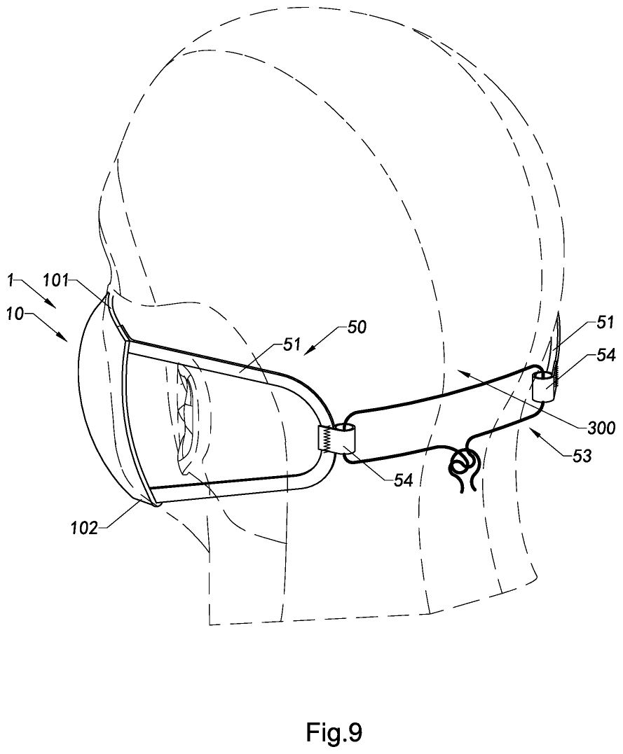

Referring to FIG. 9, a third alternative mode of the protective mask 1 according to the preferred embodiment of the present invention, wherein the head wearing member 53 of the wearing device 50 includes at least two mounting rings 54 provided at the two ear wearing members 51 respectively, and a mounting element 531, such as a string, passing through the two mounting rings 54. After the cover body 10 is worn on the user's fact, by tightening up the mounting string 531 behind the head of the user, the cover body 10 can be worn on the user's face and the two ear wearing members 51 can be stretched out to avoid applying direct stress against the ears of the user, so that the stress exerted to the user's ears by the ear wearing members 51, as in the above preferred embodiment as shown in FIGS. 1A to 8, can be transferred and released to his/her head through the head wearing member 53 that is more comfortable and rigidly mounted in position when the user have to wear the protective mask 1 for long period of time.

It is worth mentioning that the positions of the mounting rings 54 arranged on the ear wearing members 51 may vary based on the needs. For example, the mounting ring 54 is arranged on the ear wearing member 51 and close to the position of the upper edge 101 of the cover body 10. When the head wearing member 53 is tightened in order to pull the mounting member 54 so as to pull the ear wearing member 51, the position of the upper edge 101 of the cover body 10 is adapted for being tightened so as to facilitate the fitting and close attachment between the upper edge 101 of the cover body 10 and the face of the user. Alternatively, the mounting member 54 can also be arranged on the ear wearing member 51 and close to the position of the lower edge 102 of the cover body 10. When the head wearing member 53 is tightened in order to pull the mounting member 54 so as to pull the ear wearing member 51, the position of the lower edge 102 of the cover body 10 is adapted for being tightened so as to facilitate the fitting and close attachment between the lower edge 102 and the face of the user. Certainly, the mounting rings 54 may also be arranged in a middle position of the ear wearing members 51, such that when the head wearing member 53 is tightened to pull the mounting member 54 and pull the ear wearing members 51, the upper edge 101 and the lower edge 102 of the cover body 10 can both be tightened and fittingly attached on the user's face more.

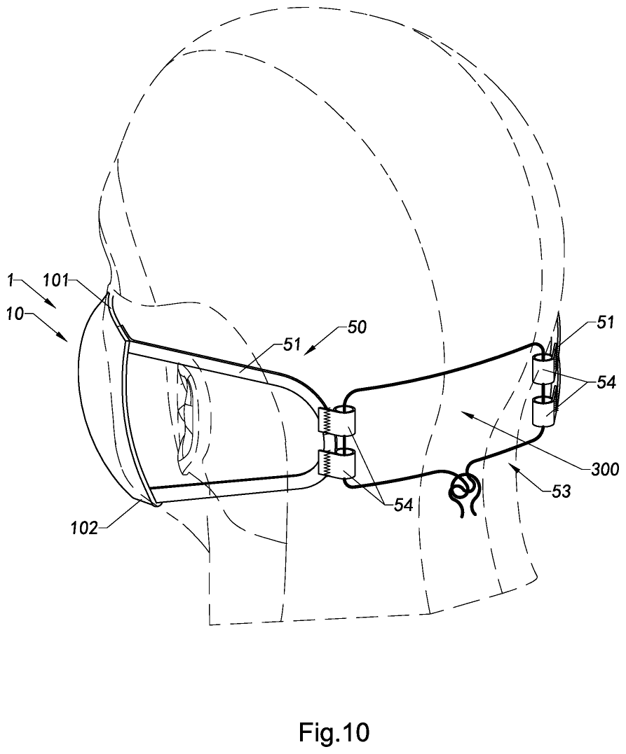

The number of the mounting rings 54 can be four or more. As shown in FIG. 10, a fourth alternative mode of the protective mask 1 of the preferred embodiment is illustrated, wherein the head mounting member 53 of the wearing device 50 is embodied to comprise two pairs of mounting rings 54 and a mounting element 531, such as a string. A pair of mounting rings 54 are connected to one of the ear wearing members 51 and the mounting element 531 is passed through the four mounting rings 54, so that after the cover body 10 is worn on the user's face, by tightening up the mounting element 531, the cover body 10 can be worn on the user's face and the two ear wearing members 51 can be stretched out to avoid applying stress against the ears of the user, so that the stress exerted to the user's ears by the ear wearing members 51, as in the above preferred embodiment as shown in FIGS. 1A to 7, can be transferred and released to his/her head through the head wearing member 53 that is more comfortable and rigidly mounted in position when the user have to wear the protective mask 1 for long period of time. In addition, when the mounting element 531 of the head wearing member 53 is tightened in order to pull the mounting rings 54 so as to pull the ear wearing members 51, the positions of both the upper edge 101 and the lower edge 102 of the cover body 10 is adapted for being tightened so as to facilitate the fitting and close attachment between the upper edge 101 and the lower edge 102 and the face of the user.

It is worth mentioning, one skilled in the art may modify the above third alternative mode that, the head wearing member 53 of the wearing device 52 may merely comprises one mounting element 531 directly tightening up between the two ear wearing members 51 with the head of the user so as to fasten and mount the cover body 10 on the user's face.

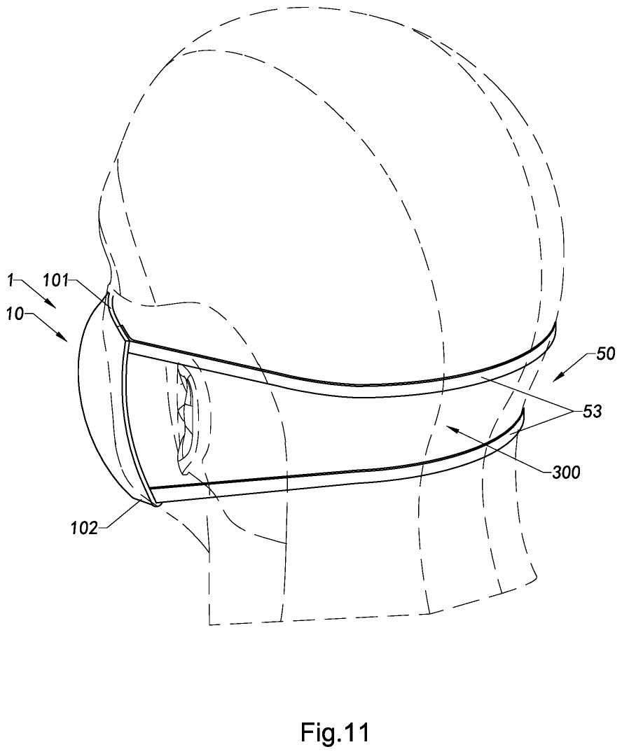

Referring to FIG. 11, a fifth alternative mode of the protective mask 1 according to the preferred embodiment of the present invention, wherein the wearing device 50 does not include ear wearing member but simply includes a head wearing member 53 which includes a pair of wearing elements each having two ends connected to the two side edges of the cover body 10 for directly stretching to extend behind the head of the user surroundingly and forming a wearing passage 300 so as to allow the protective mask 1 to be worn on the user's head directly through the head wearing member 53.

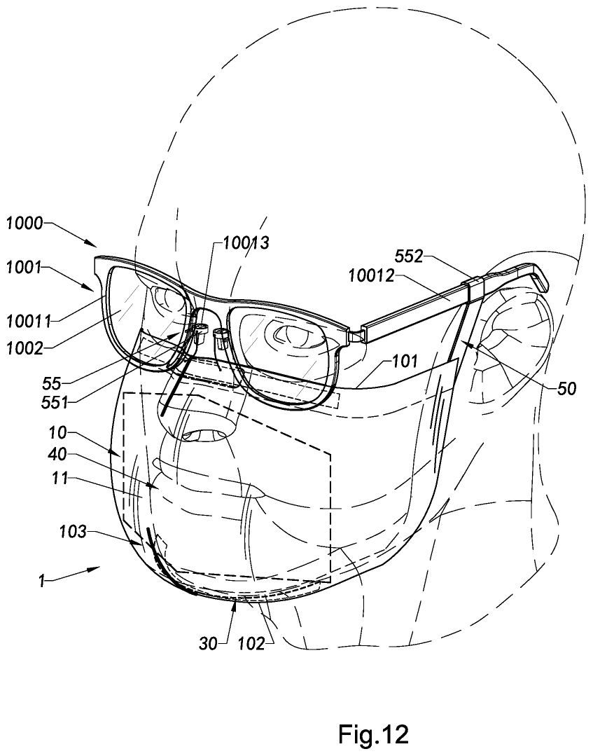

Referring to FIG. 12, a sixth alternative mode of the protective mask 1 according to the preferred embodiment of the present invention is illustrated.

A difference between this sixth alternative mode and the above preferred embodiment and its first to fifth alternative modes is at the wearing device 50, wherein the wearing device 50 comprises at least a goggle mounting member 55. The goggle mounting member 55 is configured for connecting the cover body 10 with a goggle 1000 worn by the user. The goggle 1000 may be, but not limited to, myopia glasses, sun glasses, wind goggle, protection goggle, and etc.

Through the goggle mounting member 55, the cover body 10 can be connected with the goggle, such that the protective mask 1 can be worn on the user's face through the goggle 1000 without utilizing any ear wearing members 51 or head wearing member 53 of the above preferred embodiment and its first to fifth alternative modes.

The goggle mounting member 55 can be connected with the goggle through, but not limited to, bundling, buckling, adhesive bonding, plugging, sleeving, embedding, and etc. Alternatively, the goggle mounting member 55 is dismantably connected with the goggle mounting member 55.

The goggle 1000 usually comprise a frame 1001 and at least a lens 1002. The goggle mounting member 55 can be arranged on the frame 1001 or the lens 1002. The quantity of the goggles mounting member 55 can be one or more. The goggle mounting member 55 may be, for instance, in a strip form, extended from the upper edge 101 of the cover body 10 upwardly toward the lower periphery of the frame 1001 of the goggle 1000.

The frame 1001 comprises a lens frame 10011 and two temples 10012. The two temples 10012 are respectively extended from two sides of the lens frame 10011. The goggle mounting member 55 may be mounted on the lens frame 10011 or the temples 10012.

According to the sixth alternative mode of the preferred embodiment, the goggle mounting member 55 may comprise a pair of nose pad mounting members 551 and a pair of temple mounting members 552. The nose pad mounting members are configured to be on a pair of nose pads 10013 of the frame 1001 of the goggle 1000. The temple mounting members 552 are configured to be mounted on the two temples 10012 of the frame of the goggle 1000 at, for example, positioning close to the temples 10012 of the frame of the goggle 1000.

When the nose pad mounting members 551 are mounted on the nose pads 10013 of the goggle 1000, the nose pad mounting members 551 will be positioned behind the lens frame 10011 or the lens 1002, such that when the goggle 1000 is worn by the user, the lower periphery of the goggle 1000 can be pressed on the upper edge 101 of the cover body 10, which helps fittingly attach the upper edge 101 of the cover body 10 with the user's face.

When an end of each of the temple mounting members 552 is mounted on the temples 10012 of the goggle 1000, the other end of the temple mounting members 552 is connected with a side of the lower edge 102 of the cover body 10, such that the direction of the pulling force provided by the goggle mounting member 55 will be along the direction of the lower edge 102 and the cover body 10 will be led by the goggle mounting member 55 to shape based on the low jaw of the user.

It is understandable that the position of the goggle mounting member 55 shall not be limited according to the above illustration. Rather, those skilled in the art may decide the mounting position of the goggles mounting member at the goggles 1000 based on the user's needs.

It is understandable that the protective mask 1 can further comprise the goggle 1000, wherein the cover body 10 can protect the mouth and nose and the goggle can protect the eyes, so as to reduce the risk of having the pollutant contacting the eyes. By having the cover body 10 and the goggle 1000 connected with each other, the protective mask 1 can therefore protect the eyes, nose, and mouth of the user's face.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A protective mask, adapted for wearing on a face of a user, comprising:
an upper forming member;
a cover body, configured for covering the face of the user, having a first side portion, a second side portion, an upper edge configured and shaped for being extended to an above portion of a nasal cavity opening of the user, and a lower edge configured and shaped for being extended to a chin of the user, wherein said upper forming member is long and thin and arranged along said upper edge, wherein said upper forming member is provided along said upper edge of said cover body and configured for being supported by a nose bridge of the user, wherein said upper forming member is deformable in such a manner that said upper forming member is allowed to be formed and shaped according to an outline of the nose bridge of the user so as to allow said upper edge of said cover body to be fittingly in contact with the face by deforming according to the outline of the nose bridge and extending to two cheeks of the user, wherein said cover body is configured to form and define a respiratory cavity between said upper edge and said lower edge thereof when said cover body is worn on the face of the user, so as to allow said cover body being worn in front of a nasal cavity opening and a mouth of the user while keeping a distance from the nasal cavity opening of the user, wherein said cover body comprises an outer layer and an inner layer and has a mounting pocket formed between said outer layer and said inner layer, wherein said inner layer comprises a first inner layer element having an outer side edge and a second inner layer element having one side edge extended to overlap said outer side edge of said first inner layer element, wherein said inner layer has a first receiving opening located at said first side portion of said cover body and formed between said outer side edge of said first inner layer element and said side edge of said second inner layer element for communicating said mounting pocket with outside;
at least one functional insert member which has a shape adapted to be placed in said mounting pocket and is inserted into and withdrawn from said mounting pocket through said first receiving opening, wherein when said at least one functional insert member is placed in said mounting pocket, one of two side ends of said at least one functional insert member is extended to under said first inner layer element while said side edge of said second inner layer element overlapped and covered said outer side edge of said first inner layer element closes said first receiving opening to conceal said functional insert member within said mounting pocket; and
a wearing device arranged to couple with said cover body for wearing said cover body on the face of the user.

2. The protective mask, as recited in claim 1, wherein said inner layer further comprises a third inner layer element having an outer side edge which is overlapped by another side edge of said second inner layer element, wherein said inner layer has a second receiving opening located at said second side portion of said cover body and formed between said outer edge of said third inner layer element and said another side edge of said second inner layer element, wherein said functional insert member is inserted into said aid mounting pocket through one of said first and second receiving openings and adjusted a position thereof through said first and second receiving openings by respectively pulling said two side ends of said functional insert member sidewardly until said two side ends of said functional insert member are extended under said first and third inner layer elements respectively while said two side edges of said second inner layer element cover and overlap said outer side edges of said first and third inner layer elements respectively to close up said first and second receiving openings to conceal said functional insert member within said mounting pocket of said cover body.

3. The protective mask, as recited in claim 1, further comprising a lower forming member which is arranged along said lower edge and configured for allowing said lower forming member to be formed and shaped along an outline of the chin of the user, ensuring said lower forming member is supported by the chin such that said lower edge of said cover body is fittingly attached on the chin.

4. The protective mask, as recited in claim 2, further comprising a lower forming member which is arranged along said lower edge and configured for allowing said lower forming member to be formed and shaped along an outline of the chin of the user, ensuring said lower forming member is supported by the chin such that said lower edge of said cover body is fittingly attached on the chin.

5. The protective mask, as recited in claim 3, wherein said lower forming member comprises an adjustable element provided at said lower edge of said cover body and extended along said lower edge of said cover body, wherein said wearing device comprises two ear wearing members configured for hanging on two ears of the user, wherein each of said ear wearing members is an elongated element having a first end connected to said upper edge of said cover body and a second end connected to one end of said adjustable element, such that by pulling said two ear wearing members, said adjustable edge is stretched to extend a length thereof sidewardly to enlarge a size of each of said two ear wearing members while said stretched and extended adjustable edge is adapted for fittingly attached on the chine of the user.

6. The protective mask, as recited in claim 4, wherein said lower forming member comprises an adjustable element provided at said lower edge of said cover body and extended along said lower edge of said cover body, wherein said wearing device comprises two ear wearing members configured for hanging on two ears of the user, wherein each of said ear wearing members is an elongated element having a first end connected to said upper edge of said cover body and a second end connected to one end of said adjustable element, such that by pulling said two ear wearing members, said adjustable edge is stretched to extend a length thereof sidewardly to enlarge a size of each of said two ear wearing members while said stretched and extended adjustable edge is adapted for fittingly attached on the chine of the user.

7. The protective mask, as recited in claim 5, wherein said cover body has a tubular receiving channel formed along said lower edge thereof and extended to two side edge of said cover body, wherein said adjustable element is disposed and extended along said tubular receiving channel.

8. The protective mask, as recited in claim 6, wherein said cover body has a tubular receiving channel formed along said lower edge thereof and extended to two side edge of said cover body, wherein said adjustable element is disposed and extended along said tubular receiving channel.

9. The protective mask, as recited in claim 7, wherein said second ends of said two ear wearing members are extended into said receiving channel through two ends of said tubular receiving channel and connected to said two ends of said adjustable element within said tubular receiving channel.

10. The protective mask, as recited in claim 8, wherein said second ends of said two ear wearing members are extended into said receiving channel through two ends of said tubular receiving channel and connected to said two ends of said adjustable element within said tubular receiving channel.

11. The protective mask, as recited in claim 1, wherein said cover body has at least a ridge formed on said outer layer of said cover body and extended from said upper edge of said cover body towards said lower edge for a length ensuring said respiratory cavity formed between said upper edge and said lower edge of said cover body when said cover body is worn on the face of the user.

12. The protective mask, as recited in claim 9, wherein said cover body has at least a ridge formed on said outer layer of said cover body and extended from said upper edge of said cover body towards said lower edge for a length ensuring said respiratory cavity formed between said upper edge and said lower edge of said cover body when said cover body is worn on the face of the user.

13. The protective mask, as recited in claim 10, wherein said cover body has at least a ridge formed on said outer layer of said cover body and extended from said upper edge of said cover body towards said lower edge for a length ensuring said respiratory cavity formed between said upper edge and said lower edge of said cover body when said cover body is worn on the face of the user.

14. The protection mask, as recited in claim 11, wherein said cover body has a lower ridge formed on said cover layer thereof and extended from said lower edge of said cover body towards said upper edge for a length ensuring said respiratory cavity formed between said upper edge and said lower edge of said cover body when said cover body is worn on the face of the user.

15. The protection mask, as recited in claim 12, wherein said cover body has a lower ridge formed on said cover layer thereof and extended from said lower edge of said cover body towards said upper edge for a length ensuring said respiratory cavity formed between said upper edge and said lower edge of said cover body when said cover body is worn on the face of the user.

16. The protection mask, as recited in claim 13, wherein said cover body has a lower ridge formed on said cover layer thereof and extended from said lower edge of said cover body towards said upper edge for a length ensuring said respiratory cavity formed between said upper edge and said lower edge of said cover body when said cover body is worn on the face of the user.

17. The protective mask, as recited in claim 1, wherein said wearing device further comprises a head wearing member configured for wearing said cover body on the face of the user by extending and mounting behind a head of the user.

18. The protective mask, as recited in claim 5, wherein said wearing device further comprises a head wearing member configured to be connected between said two ear wearing member for extending and fastening behind the head of the user.

19. The protective mask, as recited in claim 6, wherein said wearing device further comprises a head wearing member configured to be connected between said two ear wearing member for extending and fastening behind the head of the user.

20. The protective mask, as recited in claim 16, wherein said wearing device further comprises a head wearing member configured to be connected between said two ear wearing member for extending and fastening behind the head of the user.
